(19) United States
(12) Patent Application Publication
(10) Pub. No.: US 2016/0282131 A1
(43) Pub. Date: Sep. 29, 2016

(54) X-BAND AVIAN RADAR DETECTION AND WARNING SYSTEM

(71) Applicant: Gulfstream Aerospace Corporation, Savannah, GA (US)

(72) Inventor: Gary Palfreyman, Savannah, GA (US)

(21) Appl. No.: 14/665,418

(22) Filed: Mar. 23, 2015

(51) Int. Cl. G01C 21/34; G01S 13/42; G01S 7/41; G01S 13/93

(52) U.S. Cl. CPC G01C 21/3415; G01S 13/9303; G01S 13/426; G01S 7/415

(57) ABSTRACT

The disclosed embodiments relate to an aircraft having an X-band avian radar detection and warning system. The system can include an X-band radar system and a processor. The processor can include a target processor module that can process the reflected X-band radar signals to: detect targets in a projected flight path of the aircraft; identify one or more targets that are determined to correspond to one or more birds; and generate a bird detection signal. In response to receiving the bird detection signal, the warning generator module can generate and transmit a warning generator signal to at least one cockpit output device in the cockpit of the aircraft to cause it to generate a warning signal that is perceptible in the cabin of the aircraft to warn pilots and crew of a potential collision with the birds so that the pilot can take evasive action.

### TECHNICAL FIELD

Embodiments of the present invention generally relate to aircraft, and more particularly relate to an aircraft having an X-band radar detection system for detecting objects, such as birds, in a flight path of an aircraft and warning system for providing a warning signal to indicate presence of objects in the flight path of the aircraft.

### BACKGROUND

When an aircraft is in flight there is a risk that birds in its flight path can strike the aircraft. Bird strikes to aircraft can cause significant damage to aircraft structure. Collisions with birds can not only damage the aircraft, but can also put the aircraft out of service and result in flight cancellations. The costs associated with the repair and grounding of an aircraft can be significant. Bird strikes can be particularly problematic in the event a bird strikes one of the aircraft's engines. Although some engines are designed to ingest and process small birds (e.g., 1.8 kilograms or less), larger birds or flocks of smaller birds can cause enough damage to completely stop one or more of the engines from operating as intended. As such, the timely detection and avoidance of birds is an important issue that needs to be addressed.

Accordingly, it would be desirable to provide a system in and on the aircraft to detect birds and provide a warning to the pilot so that the pilot can take evasive action and avoid bird strikes. For example, it would be desirable to provide cost-effective systems and apparatus that can provide warning signals, alerts, or other indications that are perceptible within the cabin so that the pilot can change the flight path and thereby reduce the likelihood of and/or prevent collisions with birds that are detected. Furthermore, other desirable features and characteristics of the present invention will become apparent from the subsequent detailed description and the appended claims, taken in conjunction with the accompanying drawings and the foregoing technical field and background.

### SUMMARY

In accordance with one of the disclosed embodiments, a method is provided that is implemented onboard an aircraft. In accordance with the method, an X-band radar system receives reflected X-band radar signals that are reflected by targets. The reflected X-band radar signals are processed to detect targets in a projected flight path of the aircraft. Some of the targets can correspond to one or more birds, whereas other targets do not correspond to birds. Selected ones of the targets that are determined to correspond to one or more birds (and that are located in the projected flight path of the aircraft) can be identified, and a bird detection signal can be generated. The bird detection signal includes information for each target that has been determined to correspond to one or more birds. In response to receiving the bird detection signal, a warning generator signal can be transmitted to at least one cockpit output device in the cockpit of the aircraft.

In accordance with another one of the disclosed embodiments, an aircraft is provided that includes an avian detection and warning system mounted in the aircraft. The avian detection and warning system can include an X-band radar system and a processor. The X-band radar system is configured to receive reflected X-band radar signals. The processor can include a target processor module and a warning generator module. The target processor module can process the reflected X-band radar signals to: detect targets in a projected flight path of the aircraft; identify one or more targets that are determined to correspond to one or more birds; and generate a bird detection signal comprising: information for each target that is identified as corresponding to one or more birds. In response to receiving the bird detection signal, the warning generator module can generate and transmit a warning generator signal to at least one cockpit output device in the cockpit of the aircraft.

### DESCRIPTION OF THE DRAWINGS

Embodiments of the present invention will hereinafter be described in conjunction with the following drawing figures, wherein like numerals denote like elements, and

FIG. 1 is a plan view of an aircraft in which the disclosed embodiments can be implemented in accordance with one exemplary, non-limiting implementation;

FIG. 2 is a block diagram of a computer system that can used to implement an avian detection and warning system in accordance with an exemplary implementation of the disclosed embodiments;

FIG. 3 is a block diagram of an avian detection and warning system that can be implemented in an aircraft in accordance with an exemplary implementation of the disclosed embodiments; and

FIG. 4 is a flowchart of a method in accordance with some of the disclosed embodiments.

### DESCRIPTION OF EXEMPLARY EMBODIMENTS

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary or the following description.

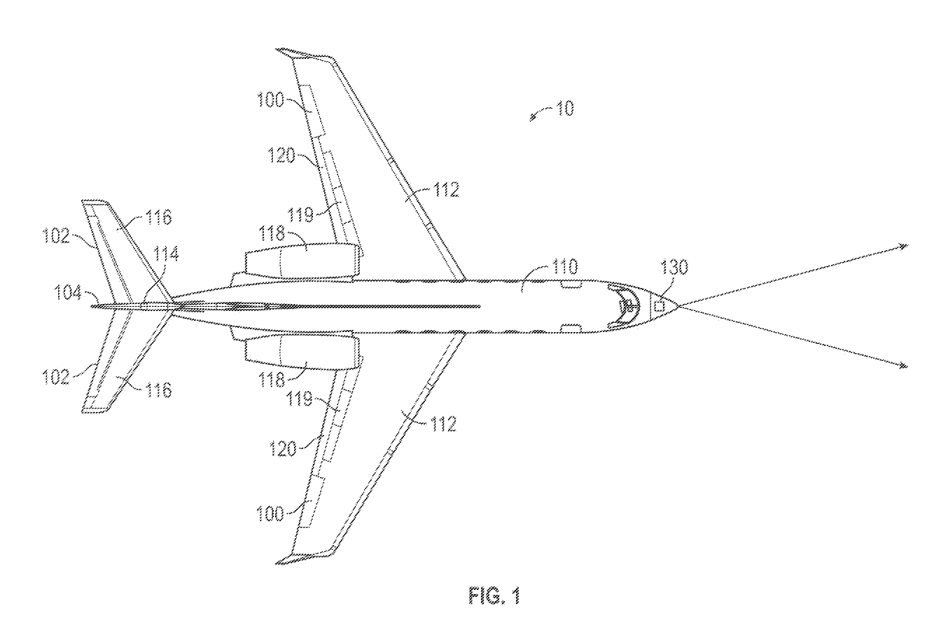

FIG. 1 is a plan view of an aircraft 10 in which the disclosed embodiments can be implemented in accordance with one exemplary, non-limiting implementation.

In accordance with one non-limiting implementation of the disclosed embodiments, the aircraft 10 includes fuselage 110, which holds the passengers and the cargo; two main wings 112, which provide the lift needed to fly the aircraft 10; a vertical stabilizer 114 and two horizontal stabilizers 116, which are used to ensure a stable flight; and two jet engines 118, which provide the thrust needed to propel the aircraft 10 forward. Although the jet engines 118 are illustrated as being mounted to the fuselage 110, this arrangement is non-limiting and in other implementations the jet engines 118 can be mounted on the wings 112. Flight control surfaces are placed on wings 112, horizontal stabilizers 116, and vertical stabilizers 114 to guide the aircraft 10. Flight control surfaces can include primary and secondary flight control surfaces. The primary flight control surfaces include the ailerons 100 located on the trailing edges of the wings of the aircraft 10, the elevators 102 located on the horizontal stabilizers 116 of an aircraft 10, and the rudder 104 located on the vertical stabilizer. The secondary flight control surfaces can include spoilers 119 and flaps 120 on the wings 112 of the aircraft 10.

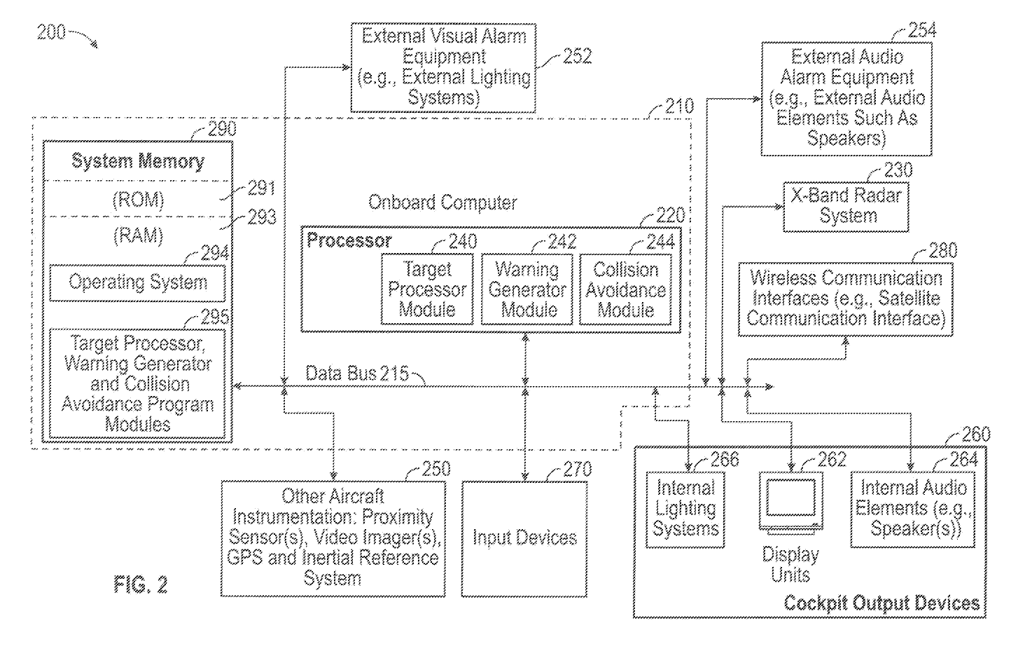

Although not shown in FIG. 1, the aircraft 10 also includes various onboard computers, aircraft instrumentation, and cockpit output devices, such as audio warning equipment and visual warning equipment. As will now be described with reference to FIGS. 2-4, in accordance with the disclosed embodiments, the aircraft 10 includes an X-band radar system 130 mounted in and/or on the aircraft 10 (e.g., in the nose cone or radome) that can be used to detect, for example, the presence of birds within a projected flight path of the aircraft 10.

FIG. 2 is a block diagram of a computer system 200 that can be located in or on an aircraft 10 (see FIG. 1) and used to implement an avian detection and warning system in accordance with an exemplary implementation of the disclosed embodiments.

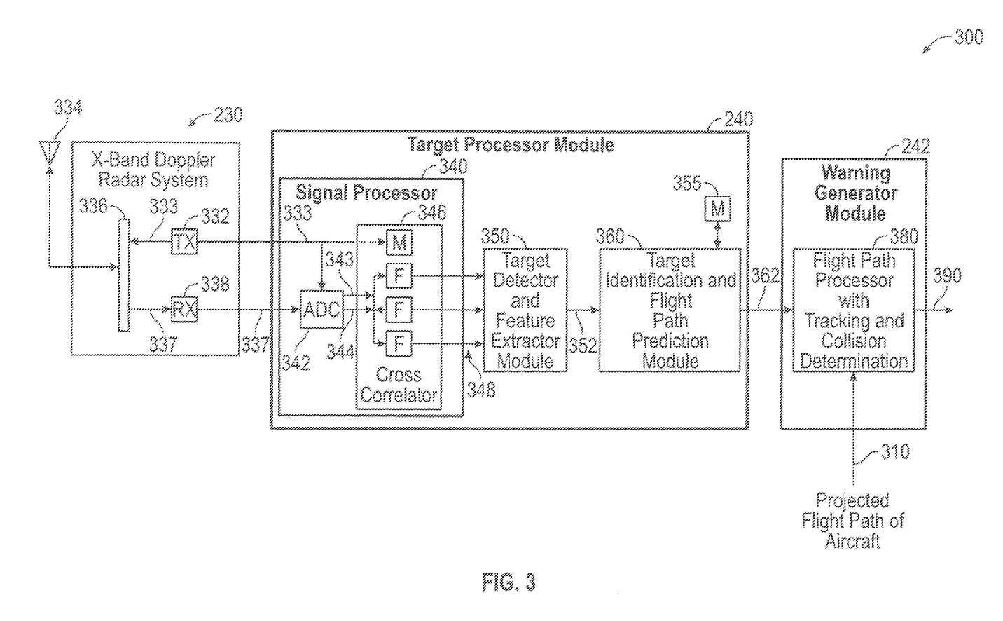

The computer system 200 includes various hardware components including an onboard computer 210, an X-band radar system 230, aircraft instrumentation 250, cockpit output devices 260, various input devices 270 such as a keypad and/or a cursor control device, and one or more touchscreen input devices which can be implemented as part of the display units, and wireless communication interfaces 280 that can be used to communicate signals with external communication interfaces, such as satellites. The interaction between the various components of the computer system 200 will be described below with reference to FIG. 3.

The onboard computer 210 includes a data bus 215, a processor 220, and system memory 290. The data bus 215 is used to carry signals communicated between the processor 220, and the other blocks of FIG. 2.

The aircraft instrumentation 250 can include, for example, the proximity sensors, video imagers, elements of a Global Position System (GPS), which provides GPS information regarding the position and speed of the aircraft, and elements of an Inertial Reference System (IRS). In general, the IRS is a self-contained navigation system that includes inertial detectors, such as accelerometers, and rotation sensors (e.g., gyroscopes) to automatically and continuously calculate the aircraft's position, orientation, heading and velocity (direction and speed of movement) without the need for external references once it has been initialized.

The cockpit output devices 260 can include apparatus that can be used to implement visual warning equipment/devices such as display units 262 including control display units, primary flight displays (PFDs), multifunction displays (MFDs), etc. The display units 262 can be implemented using any man-machine interface, including but not limited to a screen, a display or other user interface (UI). The cockpit output devices 260 can include apparatus that can be used to implement audible warning equipment/devices including internal audio elements 264, such as speakers located in the cockpit. The audio elements can include speakers and circuitry for driving the speakers. The cockpit output devices 260 can include haptic devices (not illustrated).

The input devices 270 can generally include, for example, any switch, selection button, keypad, keyboard, pointing devices (such as a cursor control device or mouse) and/or touch-based input devices including touch screen display(s) which include selection buttons that can be selected using a finger, pen, stylus, etc.

The system memory 290 can includes non-volatile memory (such as ROM 291, flash memory, etc.), volatile memory (such as RAM 292), or some combination of the two. The RAM 292 includes an operating system 294, and software that includes target processor program module and warning generator program module 295. The processor 220 executes the target processor program module and warning generator program module 295 (stored in system memory 290) to implement portions of a target processor module 240 and warning generator module 242 at processor 220 (some portions of the target processor module can be implemented in hardware depending on the implementation). The target processor and warning generator program modules 295 can include various sub-modules that will be described in conjunction with FIG. 3.

The wireless communication interfaces 280 are operatively and communicatively coupled antennas (not illustrated) that can be external to the on-board computer 210. The communication interfaces 280 can be used to communicate various signals over the air with other aircraft, satellites (e.g., GPS satellites or other means of acquiring any aspect of position or velocity of the aircraft), and ground-based computers.

As will be described in greater detail below, the target processor module 240 processes reflected X-band radar signals to detect targets in the projected flight path of the aircraft, and then identifies one or more targets located in the projected flight path of the aircraft that are determined to correspond to bird(s). In one embodiment, the target processor module 240 can detect and identify birds within six to eight kilometers of the projected flight path of the aircraft 10, and determine whether a collision between bird(s) and the aircraft is likely based on their current flight paths. When the one or more targets corresponding to birds are determined to be located in the projected flight path of the aircraft 10 and the probability of a collision with the birds exceeds a threshold, the target processor module 240 generates a bird detection signal (or signals) that are communicated to the warning generator module 242.

In response to receiving the bird detection signal, the warning generator module 242 generates and transmits a warning generator signal to one or more of the cockpit output devices 260 in the cockpit of the aircraft 10. Upon receiving the warning generator signal, one or more of the cockpit output devices 260 can then generate an alert signal that is perceptible in the cockpit of the aircraft 10. The alert signal provides the pilot with a warning that a bird airstrike is probable and may occur if the aircraft 10 maintains its current or projected flight path so that the pilot has enough time to take evasive action when bird(s) are detected in the projected flight path of the aircraft 100. Here, “perceptible in the cockpit” refers to the fact that the alert signal can be communicated to the pilot via touch, sight, or sound (e.g., via any haptic/tactile, visual, or auditory modality that provides any haptic, visual, or audible signal to warn the pilot that bird(s) are within the flight path of the aircraft 10, and that there is potential for a collision between the aircraft 100 and the bird(s)). The alert signal can be any combination of visual, audio and/or haptic indication(s).

For example, the alert signal may include an audible indication communicated via an audio system or audio elements 264 (e.g., a speaker, horn, or bell mounted within the cockpit or a speaker in a headset warn by the pilot) within the cockpit of the aircraft 10. The alert signal may also include a visual indication communicated via visual warning equipment 262, 266 mounted within the cockpit of the aircraft 10. For instance, the visual indication can be one or more of: a flashing light 266 in the cockpit of the aircraft, an image or a warning message or an image presented on a display 262 in the cockpit of the aircraft. In one implementation, images that represent birds within the field of view can be presented to the pilot on a display. In some implementations, additional information can be displayed to the pilot such as a predicted flight path of the birds and along with a projected flight path of the aircraft 10. In another embodiment, the alert signal can also include a haptic indication communicated to the pilot of the aircraft 10 to warn the pilot.

In some embodiments, the aircraft can also include various types of alarm equipment located on/in the exterior of the aircraft. For example, the aircraft can include external visual alarm equipment/devices 252 that are mounted in and/or on the exterior of the aircraft 100 and can include any known types of visual alarm equipment (e.g., lighting systems), and external audio alarm equipment/devices 254 that are mounted in and/or on the exterior of the aircraft 100 and can include any known types audio elements (e.g., speakers, horns, etc.).

Further, in some embodiments, the warning generator module 242 generates and communicates a warning generator signal to a collision avoidance module 244 that is executed within the processor 220. The collision avoidance module 244 can generate control signals that control external visual alarm equipment 252 and/or external audio alarm equipment 254 to help avoid birds that may lie within the aircraft's flight path. For example, in one embodiment, the collision avoidance module 244 can generate control signals that control the external visual alarm equipment 252 to cause external lights to flash at different frequencies to warn the birds that the aircraft is approaching and scare them into deviating from the current flight pattern. In addition, the collision avoidance module 244 can also generate control signals that control the external audio alarm equipment 254 to generate sound to warn the birds that the aircraft is approaching and scare them into deviating from the current flight pattern. These approaches can help eliminate the need for the pilot to change the aircraft's flight path.

FIG. 3 is a block diagram of an avian detection and warning system 300 that can be implemented in an aircraft 10 (see FIG. 1) in accordance with an exemplary implementation of the disclosed embodiments. FIG. 3 will be described with reference to FIG. 2. The avian detection and warning system 300 comprises an X-band radar system 230, a target processor module 240, and a warning generator module 242.

The X-band radar system 230 can be mounted in or on the aircraft 10 (e.g., in the nose cone or radome as illustrated in FIG. 1.) The radar system is configured to scan a projected flight path 310 of the aircraft 10 for “targets” within the projected flight path 310. As used herein, the term “target” refers to a moving object that is capable of reflecting an X-band radar signal. In general terms, the radar system 230 utilizes electro-magnetic energy (in the microwave range) to gather information about remote targets by analyzing the characteristics of their reflected energy.

The X-band radar system 230 can vary depending on the implementation. According to some embodiments, the X-band radar system 230 can be configured as a Continuous Wave (CW) radar system, such as a Frequency Modulated (FM) Continuous Wave (CW) radar system. In other embodiments, the X-band radar system 230 can be configured as a pulsed Doppler radar system. CW radar systems utilize periodic variations in frequency to determine the range to the target. By contrast, a Doppler radar system relies on the Doppler effect to isolate moving targets and determine their velocities relative to the radar antenna, but is incapable of determining the range to the target. As such, in some embodiments, the X-band radar system 230 can be configured with features of both FMCW and Doppler operation. For example, in one embodiment, the X-band radar system 230 can be configured as a pulsed Doppler radar system that combines features of conventional pulse radar systems and continuous-wave radar systems. The pulsed Doppler radar system determines the range to a target using pulse-timing techniques, and uses the Doppler shift of the returned signal to determine the target's velocity. In another embodiment, the X-band radar system 230 can be configured as a frequency modulated (FM) continuous wave (CW) Doppler radar system. In one particular implementation, the X-band radar system 230 can be implemented using a weather radar system that is already present on many aircraft (e.g., an airborne pulse-Doppler weather radar system).

Regardless of the configuration, the X-band radar system 230 includes a transmitter 332, one or more antennas 334, and a receiver 338. In a monostatic embodiment, such as the one illustrated in FIG. 3, the transmitter 332 and the receiver 338 are co-located and communicatively coupled to the antenna 334 via a coupler 336. In an alternative, bistatic embodiment (not illustrated), the transmitter 332 and the receiver 338 are not co-located and each has their own separate antenna (not illustrated).

The X-band radar system 230 operates in the X-band frequency range, which refers to a segment of the microwave radio region of the electromagnetic spectrum. In radar engineering, the frequency range is typically specified as covering 8.0 to 12.0 GHz. One benefit of the X-band radar system is that it is characterized by low atmospheric absorption. In addition, shorter X-band wavelengths allow for relatively high resolution imagery for target identification and discrimination, which is important in distinguishing between birds versus other targets that are detected.

As such, the transmitter 332 is designed or configured to transmit, via the one or more antennas 334, X-band radar signals 333, and the receiver 338 is designed or configured to receive (or acquire) reflected X-band radar signals 337. The transmitted X-band radar signals 333 are reflected by targets to produce the reflected X-band radar signals 337. As noted above, the X-band radar signals have a frequency between 8 gigahertz and 12 gigahertz, and in one implementation of the disclosed embodiments, between 9 gigahertz and 9.5 gigahertz (e.g., 9.375 gigahertz). As will be described below, these reflected X-band radar signals 337 can be processed to detect and identify targets (including birds) within a projected flight path 310 of the aircraft 10. To avoid confusion in the description that follows, X-band radar signals 333 transmitted by the transmitter 332 will be referred to herein as “transmitted X-band radar signals 333” to distinguish them from “reflected X-band radar signals 337” that are received by the receiver 338. In one embodiment, the transmitter 332 generates a pulsed radar signal and the antenna(s) 334 transmit the signal as a pulsed radar beam. The pulses can be transmitted at a repetition frequency (i.e., the pulses repeat at a particular frequency). The pulses are encoded with information so that they can be identified. When at least some of the pulses are reflected by a target in the flight path of the aircraft, such as a bird or flock of birds, this information can be received by the antennas and acquired by the receiver 338. The reflected pulses can then be processed to construct an image of any targets, etc.

The antenna(s) 334 can vary depending on the implementation. A benefit of using antennas that operate in the X-band frequency range is that the relationship between wavelength used and size of the antenna(s) 334 is considerably better than in lower frequency-bands. As such, a very small sized antenna can provide a good performance. The small size is beneficial in that they take up less space and weigh less than other antennas. This is important in an aircraft because the antennas are easy to maneuver so that they can be adjusted as the aircraft moves up, down, left, and right, and rolls so that the radar can remain pointed toward the desired flight path as the aircraft moves. In one embodiment, the antenna can be implemented as a moveable flat plate antenna that has a 1 to 3 second scan period to track targets. In one implementation, the antenna is linked and calibrated to the vertical gyro located on the aircraft so that the antenna remains pointed in the right direction under maneuvers. In other embodiments, the antenna 334 can be a phased array antenna, a phased array patch antenna, a parabolic antenna, a helical antenna, or a horn antenna.

The field of view and range of the X-band radar system 230 are configurable and can vary depending on the implementation and design of the aircraft 10 so that the detection zone that is monitored can be adjusted. In one implementation, the field of view of the X-band radar system 230 can be up to 30 degrees, and the range can be up to eight kilometers.

As described briefly above with reference to FIG. 2, in one embodiment, an onboard computer 210 can include a processor 220 that can be used to implement the target processor module 240, and the warning generator module 242. In other embodiments, the target processor module 240 and the warning generator module 242 can be implemented anywhere else on the aircraft 10.

The target processor module 240 includes a signal processor 340 that includes an analog-to-digital converter (ADC) 342 and a correlator 346, a target detector and feature extraction module 350 and a target identification and flight path predication module 360.

Although not illustrated in FIG. 3, those skilled in the art will appreciate that prior to the ADC 342 various other components to convert the signals 333, 337. Examples of such components include an RF front end with components such as low noise amplifiers, fixed oscillators, intermediate filters, programmable oscillators, etc. The ADC 342 converts the analog X-band radar signals 333, 337 to generate digitized versions of those signals. In other words, the ADC 342 digitizes the transmitted X-band radar signals 333 and the reflected X-band radar signals 337 to generate digitized transmitted X-band radar signals 343 and digitized reflected X-band radar signals 344. The correlator 346 performs additional processing on the digitized signals 343, 344 to generate the processed X-band radar signals 348. For example, in one embodiment, the correlator 346 can process the digitized transmitted X-band radar signals 343 and the digitized X-band radar signals 344. In one implementation, during processing of the digitized X-band radar signals 343, 344, the correlator 346 can cross-correlate the digitized X-band radar signals 343, 344 using a Doppler bank of matched filters (F) to generate cross-correlated X-band radar signals 348.

The target detector and feature extraction module 350 detects targets and then for each target that is detected, extracts features regarding those targets so that they can be used to identify and distinguish those targets. Target detection can involve numerous steps. For example, in one embodiment, the target detector and feature extraction module 350 can quantize amplitude, range and Doppler shift of the cross-correlated X-band radar signals, and also perform other processing steps on the signals 348 provided from the correlator 346. For instance, the target detector and feature extraction module 350 can include a noise elimination and clutter removal module (not illustrated) that removes remove extraneous information from the processed X-band radar signals 348. This way, information that is noise or corresponds to particular targets that are known not to correspond to bird(s) can be eliminated so that information does not have to be processed by the target identification and flight path predication module 360 when attempting to identify which targets correspond to bird(s).

Once targets have been detected there is still no way of knowing whether or not the target corresponds to bird(s) or something else, such as a cloud. In other words, the detected targets could be bird(s) or some other thing. As such, it is necessary to obtain or extract additional information about each target so that the various detect targets can be distinguished as corresponding to birds or something else during target identification. During the feature extraction, the target detector and feature extraction module 350 can extract identification features and generate the target information 352 for each target. Among other things, feature extraction can include determining a current three-dimensional position, a current range (distance between that target and the aircraft), a current flight speed and a current heading for each target. Feature extraction can also include computing a Doppler signature for each target (if possible), filtering and aligning each Doppler signature to compensate the Doppler shift caused by the target's motion, and then extracting certain identification features from the Doppler signature for each target that can be used to identify whether that target is a bird (or flock of birds) versus something else. It should be noted that for some targets it is not possible to compute a Doppler signature so the target detector and feature extraction module 350 can only compute a Doppler signature for certain targets that have an identifiable Doppler signature.

The extracted identification features and other target information 352 for each target can then be used at the target identification and flight path predication module 360 to identify whether a particular target corresponds to one or more birds, or something else. Depending on the implementation, the target identification and flight path predication module 360 may filter the targets to determine which ones are located in the projected flight path 310 of the aircraft 10, and then perform processing for only those targets that are determined to be located in the projected flight path 310.

In one embodiment, the target identification and flight path predication module 360 processes extracted identification features and other target information 352 to identify selected ones of the targets that are determined to correspond to one or more birds, and then for each target that is detected and identified as corresponding to one or more birds, computes a predicted flight path for that target through three-dimensional space. Each predicted flight path can be computed, for example, based on the current three-dimensional position, the current flight speed and the current heading of that target. This way, the system can localize “bird” targets in three dimensions (latitude, longitude, and height) and characterize their predicted flight path(s).

In one embodiment, to determine which targets correspond to bird(s), the target identification and flight path predication module 360 can execute a matching algorithm that compares the Doppler signature for each target to a set of pre-determined Doppler signatures (stored in a database in memory 355) to identify which targets correspond to one or more birds. The memory 355 can be implemented as part of system memory 290. Each of the pre-determined Doppler signatures is determined a priori (e.g., measured and collected based on field measurements of birds in flight, etc.) and stored in a database.

In one particular embodiment, the target identification and flight path predication module 360 can use selected identification features extracted from each particular Doppler signature of each target to identify which targets corresponds to bird(s). For instance, the target identification and flight path predication module 360 can compare or match these selected identification features (for each particular Doppler signature) with pre-determined identification features for the pre-determined Doppler signatures to identify whether that target corresponds to one of the pre-determined Doppler signatures.

Once target identification is complete, the target identification and flight path predication module 360 generates a bird detection signal 362. The bird detection signal 362 includes information for each target that is detected and identified as corresponding to one or more birds. The information included in the bird detection signal 362 for each target can include, for example, the three-dimensional position, the flight speed, the heading, the range, and the predicted flight path of that target.

The warning generator module 242 includes a flight path processor 380 that can track flight paths of the bird(s) and the aircraft and determine the probability of a collision with the bird(s). In one embodiment, the flight path processor 380 receives the projected flight path 310 of the aircraft 10 (e.g., from a subsystem of the onboard computer 210 such as a Flight Management System (FMS)) and the bird detection signal 362. The flight path processor 380 processes data that indicates the projected flight path 310 of the aircraft 10 and data for each target from the bird detection signal 362 that indicates the predicted flight paths for each of the bird(s). As part of this processing, the flight path processor 380 can determine whether the probability of a collision exceeds a threshold. The flight path processor 380 can determine whether the probability of a collision exceeds a threshold in varying ways depending on the implementation. For instance, in one embodiment, the flight path processor 380 can determine whether a predicted flight path for particular bird(s) will be within a proximity threshold of the current, projected flight path 310 of the aircraft 10. The proximity threshold is adjustable and can be configured as desired. In one implementation, the flight path processor 380 can compare the projected flight path 310 of the aircraft 10 to the predicted bird flight path to determine whether the paths come within a certain threshold that indicates that they are close to intersecting or will intersect.

When the flight path processor 380 determines that the probability of a collision exceeds a threshold, the warning generator module 242 generates and transmits the warning generator signal 390 to one or more of the cockpit output devices 260 (FIG. 2) in the cockpit of the aircraft 10. As described above with reference to FIG. 2, in response to the warning generator signal 390, one or more of the cockpit output devices 260 (FIG. 2) can then generate an alert signal that is perceptible in the cockpit of the aircraft 10 to warn the pilot that a collision is possible or likely if the aircraft 10 maintains the projected flight path 310. This way the pilot can take evasive action to avoid a bird strike.

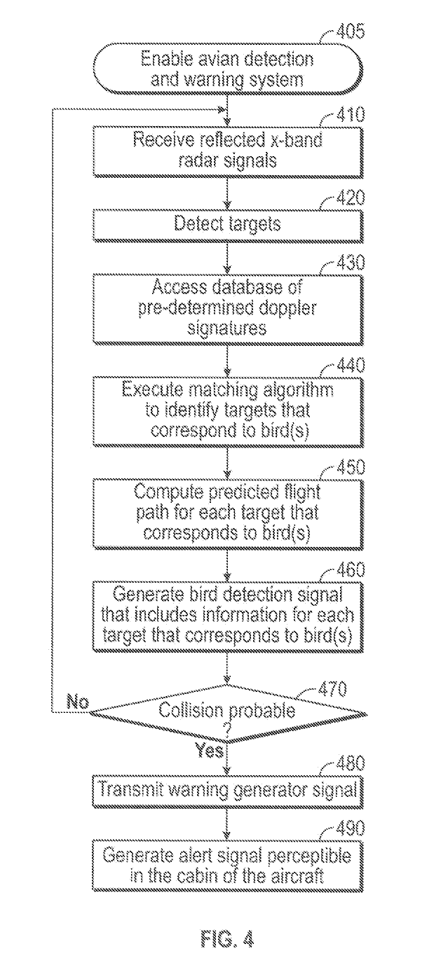

Further operational details of the collision warning and avoidance system 300 will now be described with reference to FIG. 4.

FIG. 4 is a flowchart of a method 400 in accordance with some of the disclosed embodiments. The method 400 of FIG. 4 will be described below with reference to FIGS. 1-3 to explain how the method 400 could be applied in the context of one exemplary, non-limiting environment. It is noted that all the blocks/tasks/steps do not necessarily need to be performed in every implementation. In some implementations one or any combination of blocks/tasks/steps of FIG. 4 can be performed.

The method 400 begins at 405 when the avian detection and warning system 300 is enabled, and the X-band radar system 230 begins transmitting X-band radar signals 333. The system 300 can be enabled, for example, prior to take off while the aircraft 10 is on the ground and beings moving over a certain threshold ground speed. Alternatively, the system can be disabled until the aircraft is in the air.

At 410, the receiver 338 of the X-band radar system 230 begins receiving reflected X-band radar signals 337 that are reflected by targets.

At 420, the signal processor 340 processes the reflected X-band radar signals 337 and detects targets in the projected flight path 310 of the aircraft.

Processing of the reflected X-band radar signals 337 can include, for example, digitizing transmitted X-band radar signals 333 and the reflected X-band radar signals 337 to generate digitized transmitted X-band radar signals 343 and digitized reflected X-band radar signals 344. The digitized transmitted X-band radar signals 343 and the digitized X-band radar signals 344 can then be input into a cross-correlator 346 (e.g., a Doppler bank of matched filters (F)) that cross-correlates the digitized X-band radar signals 343, 344 to generate cross-correlated X-band radar signals 348. The target detector and feature extraction module 350 can then quantize amplitude, range and Doppler shift of the cross-correlated X-band radar signals, and extract identification features for each target. As part of this extraction processing, the target detector and feature extraction module 350 can determine a current three-dimensional position, a current range, a current flight speed and a current heading for each target, and compute a Doppler signature for each target that can be used to identify whether that target corresponds to bird(s).

The target detector and feature extraction module 350 can then communicate target information 352 for each target that is detected to the target identification and flight path predication module 360. For each target this target information 352 can include a current three-dimensional position, a current flight speed, a heading, a current range from the aircraft, and a Doppler signature.

Some of the targets that are detected can correspond to bird(s), while others do not. At 430 and 440, the target identification and flight path predication module 360 can perform processing to determine which targets correspond to bird(s). For example, at 430, the target identification and flight path predication module 360 can access, from a memory 355, a set of pre-determined Doppler signatures that have been determined to correspond to bird(s) in flight. At 440, the target identification and flight path predication module 360 can execute a matching algorithm that compares the Doppler signature (or identification features for that Doppler signature) for each target to a set of pre-determined Doppler signatures (identification features for that pre-determined Doppler signature) to identify which ones of the targets correspond to bird(s).

At 450, the target identification and flight path predication module 360 can compute, for each target that is detected and identified as corresponding to bird(s), a predicted flight path through three-dimensional space, based on a current three-dimensional position, a current flight speed and a current heading of that target.

At 460, the target identification and flight path predication module 360 can generate a bird detection signal 362 that includes information for each target that is identified as corresponding to bird(s). In one embodiment, the bird detection signal 362 for each target can include, for example, information regarding the three-dimensional position, the flight speed, the heading, the range, and the predicted flight path.

At 470, the flight path processor 380 can determine whether a collision between the aircraft and bird(s) is probable. How this determination is made can vary depending on the implementation. For example, in one embodiment, the flight path processor 380 can process data that indicates the projected flight path 310 of the aircraft 10 and other data from the bird detection signal 362 that indicates the predicted flight paths to determine whether a probability of a collision exceeds a threshold.

At 480, when the flight path processor 380 determines that a collision between the aircraft and bird(s) is probable, the flight path processor 380 can generate and transmit a warning generator signal to at least one cockpit output device 260 in a cockpit of the aircraft 10. At 490, in response to the warning generator signal 390, one or more of the cockpit output device 260 can generate an alert signal that is perceptible in the cockpit of the aircraft 10.

The flowchart that is illustrated in FIG. 4 is exemplary, and is simplified for sake of clarity. In some implementations, additional blocks/tasks/steps can be implemented even though they are not illustrated in FIG. 4 for sake of clarity. These additional blocks/tasks/steps may occur before or after or in parallel and/or concurrently with any of the blocks/tasks/steps that are illustrated in FIG. 4. It is also noted that some of the blocks/tasks/steps illustrated in FIG. 4 may be optional and do not need to be included in every implementation of the disclosed embodiments. In some implementations, although not illustrated, the presence or absence of certain conditions may need to be confirmed prior to execution of a block/task/step or prior to completion of a block/task/step. In other words, a block/task/step may include one or more conditions that are to be satisfied before proceeding from that block/task/step to the next block/task/step. For example, in some cases, a timer, a counter or combination of both may execute and need to be satisfied before proceeding to the next block/task/step of the flowchart. As such, any block/task/step can be conditional on other blocks/tasks/steps that are not illustrated.

It is also noted that there is no order or temporal relationship implied by the flowchart of FIG. 4 unless the order or temporal relationship is expressly stated or implied from the context of the language that describes the various blocks/tasks/steps of the flowchart. The order of the blocks/tasks/steps can be varied unless expressly stated or otherwise implied from other portions of text.

In addition, in some implementations, FIG. 4 may include additional feedback or feedforward loops that are not illustrated for sake of clarity. The absence of a feedback or a feedforward loop between two points of the flowchart does not necessarily mean a feedback or feedforward loop is not present between the two points. Likewise, some feedback or feedforward loops may be optional in certain implementations. Although FIG. 4 is illustrated as including a single iteration this does not necessarily imply that the flowchart does not execute for a certain number of iterations or continuously or until one or more conditions occur.

Those of skill in the art would further appreciate that the various illustrative logical blocks/tasks/steps, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. For example, although the description above describes methods and systems for detecting birds, it should be appreciated that these methods and systems can be modified or adapted to also detect other airborne threats, such as drones or unmanned air vehicles (UAVs), that are flying in the flight path of the aircraft and provide a warning that these obstacles are in the flight path of the aircraft. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A method implemented onboard an aircraft, comprising:
receiving, via an X-band radar system, reflected X-band radar signals that are reflected by targets;
processing the reflected X-band radar signals to detect targets in a projected flight path of the aircraft, wherein each target detected comprises either: a target that corresponds to one or more birds, or a target that does not correspond to one or more birds;
identifying selected ones of the targets that are located in the projected flight path of the aircraft and that are determined to correspond to one or more birds;
generating a bird detection signal comprising: information for each target that is identified as corresponding to one or more birds; and
transmitting, in response to receiving the bird detection signal, a warning generator signal to at least one cockpit output device in a cockpit of the aircraft.

2. The method according to claim 1, wherein the information for each target that is identified as corresponding to one or more birds, comprises: target information for each target that is detected, the target information comprising: a current three-dimensional position, a current flight speed, a heading, a current range from the aircraft, and a Doppler signature.

3. The method according to claim 1, wherein processing the reflected X-band radar signals comprises:
digitizing transmitted X-band radar signals and the reflected X-band radar signals to generate digitized transmitted X-band radar signals and digitized reflected X-band radar signals; and
processing the digitized transmitted X-band radar signals and the digitized X-band radar signals to generate the processed X-band radar signals.

4. The method according to claim 3, wherein processing the digitized transmitted X-band radar signals and the digitized X-band radar signals, comprises:
cross-correlating the digitized transmitted X-band radar signals and the digitized X-band radar signals using a Doppler bank of matched filters to generate cross-correlated X-band radar signals;
quantizing amplitude, range and Doppler shift of the cross-correlated X-band radar signals; and
extracting identification features for each target, wherein extracting comprises:
determining a current three-dimensional position, a current range, a current flight speed and a current heading for each target, and
computing a Doppler signature for each target that can be used to identify whether that target corresponds to one or more birds.

5. The method according to claim 4, further comprising:
computing a predicted flight path through three-dimensional space for each target that is detected and identified as corresponding to one or more birds, based on a current three-dimensional position, a current flight speed and a current heading of that target,
wherein the bird detection signal for each target comprises: the three-dimensional position, the flight speed, the heading, the range, and the predicted flight path.

6. The method according to claim 4, further comprising:
accessing, from a memory, a set of pre-determined Doppler signatures that have been determined to correspond to one or more birds in flight; and
wherein identifying selected ones of the targets comprises:
executing a matching algorithm that compares the Doppler signature for each target to a set of pre-determined Doppler signatures to identify the selected ones of the targets that correspond to one or more birds.

7. The method according to claim 6, wherein each of the Doppler signatures comprises: identification features for that Doppler signature, wherein each of the pre-determined Doppler signatures comprises: pre-determined identification features for that pre-determined Doppler signature, and wherein executing a matching algorithm comprises:
comparing the identification features for each particular Doppler signature of each target with the pre-determined identification features for the pre-determined Doppler signatures to identify whether that target corresponds to one of the pre-determined Doppler signatures of one or more birds.

8. The method according to claim 5, further comprising:
receiving the projected flight path of the aircraft and the bird detection signal;
processing data that indicates the projected flight path of the aircraft and data from the bird detection signal that indicates the predicted flight paths to determine whether a probability of a collision exceeds a threshold; and
wherein transmitting the warning generator signal, comprises:
when the flight path processor determines that the probability of a collision exceeds a threshold: transmitting the warning generator signal.

9. The method according to claim 1, further comprising:
generating, via the at least one cockpit output device, responsive to the warning generator signal, an alert signal that is perceptible in the cockpit of the aircraft.

10. An aircraft comprising:
an avian detection and warning system mounted in the aircraft, and comprising:
an X-band radar system configured to receive reflected X-band radar signals; and
a processor comprising:
a target processor module configured to process the reflected X-band radar signals to: detect targets in a projected flight path of the aircraft; identify one or more targets that are determined to correspond to one or more birds; and generate a bird detection signal comprising: information for each target that is identified as corresponding to one or more birds; and
a warning generator module configured to generate and transmit, in response to receiving the bird detection signal, a warning generator signal to at least one cockpit output device in a cockpit of the aircraft.

11. The aircraft according to claim 10, wherein the target processor module comprises:
a target detector and feature extraction module configured to detect targets based on processed X-band radar signals, and generate target information for each target that is detected, wherein the target information for each target comprises: a current three-dimensional position, a current flight speed, a heading, a current range from the aircraft, and a Doppler signature.

12. The aircraft according to claim 11, wherein each target detected comprises either: a target that corresponds to one or more birds, or a target that does not correspond to one or more birds, and wherein the target processor module further comprises:
a target identification and flight path predication module configured to process the target information to:
identify selected ones of the targets that are located in the projected flight path of the aircraft and that are determined to correspond to one or more birds;
compute a predicted flight path through three-dimensional space for each target that is detected and identified as corresponding to one or more birds, wherein each predicted flight path is computed based on the current three-dimensional position, the current flight speed and the current heading of that target; and
generate the bird detection signal that comprises: information for each target that is detected and identified as corresponding to one or more birds, the information comprising: the three-dimensional position, the flight speed, the heading, the range, and the predicted flight path.

13. The aircraft according to claim 11, wherein the warning generator module comprises:
a flight path processor configured to:
receive the projected flight path of the aircraft and the bird detection signal;
process data that indicates the projected flight path of the aircraft and data from the bird detection signal that indicates the predicted flight paths for each bird to determine whether the probability of a collision exceeds a threshold; and
generate and transmit the warning generator signal when the flight path processor determines that the probability of a collision exceeds a threshold.

14. The aircraft according to claim 12, wherein a memory is configured to store a set of pre-determined Doppler signatures that have been determined to correspond to one or more birds in flight, and wherein the target identification and flight path predication module is further configured to determine the selected ones of the targets that correspond to birds by executing a matching algorithm that compares the Doppler signature for each target to a set of pre-determined Doppler signatures to identify the selected ones of the targets that are determined to correspond to one or more birds.

15. The aircraft according to claim 12, wherein each of the pre-determined Doppler signatures comprises pre-determined identification features for that pre-determined Doppler signature, and wherein the target identification and flight path predication module is further configured to compare the identification features for each particular Doppler signature of each target with pre-determined identification features for the pre-determined Doppler signatures to identify whether that target corresponds to one of the pre-determined Doppler signatures of one or more birds.

16. The aircraft according to claim 12, wherein the target detector and feature extraction module comprises:
a noise elimination and clutter removal module configured to remove extraneous information from the processed X-band radar signals to eliminate particular targets that are known not to correspond to one or more birds so that those particular targets are not considered by the target identification and flight path predication module when identifying which targets correspond to one or more birds.

17. The aircraft according to claim 10, wherein the X-band radar system is further configured to transmit transmitted X-band radar signals that are reflected by targets to produce the reflected X-band radar signals, and wherein the target processor module further comprises:
a signal processor comprising: an analog-to-digital converter (ADC) configured to digitize the transmitted X-band radar signals and the reflected X-band radar signals to generate digitized transmitted X-band radar signals and digitized reflected X-band radar signals; and a correlator configured to process the digitized transmitted X-band radar signals and the digitized X-band radar signals to generate the processed X-band radar signals.

18. The aircraft according to claim 17, wherein the correlator comprises:
a Doppler bank of matched filters, and
wherein, during processing of the digitized transmitted X-band radar signals and the digitized X-band radar signals, the correlator of the signal processor is further configured to: cross-correlate the digitized transmitted X-band radar signals and the digitized X-band radar signals using the Doppler bank of matched filters to generate cross-correlated X-band radar signals.

19. The aircraft according to claim 18, wherein, the target detector and feature extraction module is configured to:
quantize amplitude, range and Doppler shift of the cross-correlated X-band radar signals during target detection; and
during the feature extraction, extract identification features for each target and generate the target information for each target, wherein feature extraction comprises: determining a current three-dimensional position, a current range, a current flight speed and a current heading for each target, and computing a Doppler signature for each target that can be used to identify whether that target corresponds to one or more birds.

20. The aircraft according to claim 10, wherein the at least one cockpit output device is configured to generate, responsive to the warning generator signal, an alert signal that is perceptible in the cockpit of the aircraft.
